(19) United States
(12) Patent Application Publication
(10) Pub. No.: US 2024/0009613 A1
(43) Pub. Date: Jan. 11, 2024

(54) CO2 CAPTURE SORBENTS WITH LOW REGENERATION TEMPERATURE AND HIGH DESORPTION RATES

(71) Applicant: SUSTEON INC., Cary, NC (US)

(72) Inventors: Shaojun James Zhou, Cary, NC (US); Raghubir Prasad Gupta, Durham, NC (US)

(21) Appl. No.: 18/042,161

(22) PCT Filed: Aug. 16, 2021
(86) PCT No.: PCT/US2021/046103

§ 371 Date: Feb. 17, 2023

Related U.S. Application Data
(60) Provisional application No. 63/066,460, filed on Aug. 17, 2020.

(51) Int. Cl. B01D 53/02; B01J 20/32; B01J 20/10; B01J 20/22; B01J 20/30

(52) U.S. Cl. CPC B01D 53/02; B01J 20/3204; B01J 20/3248; B01J 20/3285; B01J 20/3287; B01J 20/103; B01J 20/22; B01J 20/305; B01D 2253/20; B01D 2253/25; B01D 2257/504; B01D 2253/106; B01D 2258/06; B01D 2258/0283

(57) ABSTRACT

A sorbent useful for CO₂ capture is described, including a solid support with CO₂-sorbing amine and ionic liquid thereon. The ionic liquid is catalytically effective to enhance sorbent characteristics such as (i) CO₂ sorption capacity, (ii) CO₂ sorption rate, (iii) CO₂ desorption capacity, (iv) CO₂ desorption rate, and (v) regeneration temperature, in relation to a corresponding sorbent lacking the ionic liquid. In specific implementations, the sorbent is regenerable at temperatures significantly below 100° C., thereby avoiding the need for steam heat desorption and enabling utilization of waste heat or other low energy thermal regeneration sources.

### CROSS-REFERENCE TO RELATED APPLICATION

The benefit under 35 USC § 119 of U.S. Provisional Patent Application 63/066,460 filed Aug. 17, 2020 in the names of Shaojun James Zhou and Raghubir Prasad Gupta for “CO₂ Capture Sorbents with Low Regeneration Temperature and High Desorption Rates” is hereby claimed. The disclosure of U.S. Provisional Patent Application 63/066,460 is hereby incorporated herein by reference, in its entirety, for all purposes.

### FIELD

The present disclosure relates to sorbents useful for CO₂ capture, CO₂ capture systems including such sorbents, and to methods for making and using such sorbents.

### DESCRIPTION OF THE RELATED ART

Carbon dioxide (CO₂) capture and sequestration is the focus of a vast spectrum of technological efforts to address the billions of tons of CO₂ that are generated annually by combustion engine vehicles, power generation plants, and other industrial and commercial processes.

The existing standard process for CO₂ capture employs aqueous amine solutions to absorb CO₂ from CO₂-containing gases that are subjected to gas/liquid contacting with such solutions. Although such process for CO₂ capture utilizing aqueous amine solutions has achieved significant implementation, and although various efforts have been made to enhance such process, the liquid solution approach has a number of fundamental deficiencies.

These deficiencies include problems of aging and degradation of the amine in the solution, with the result that the amine solution must be reclaimed or changed out, with corresponding cessation or interruption of CO₂ capture operations.

Further, since the contacting of the CO₂-containing gas must occur with the liquid solution, it is typically necessary to contact the CO₂-containing gas with the liquid in a packed or tray column in order to generate the large gas/liquid interfacial area necessary for CO₂ removal via vapor/liquid equilibrium. The intimate and large interfacial area contact between the gas and the liquid causes entrainment of the liquid in the gas stream, foaming, and emission of the liquid into the surrounding environment. In addition, motors or other motive driver assemblies are required to recirculate liquid in the gas/liquid contacting vessel, at a sufficient rate to maintain effective CO₂ removal, and in the regeneration operation, the released CO₂ must be separated from the liquid solution, and in many instances, must be processed to remove water vapor therefrom to accommodate the further use or disposition of the CO₂.

Accordingly, the aqueous liquid amine solution contacting of CO₂-containing gas has a number of disadvantageous aspects and features related to the use of the aqueous liquid amine solution.

As a result of these deficiencies of conventional amine solution CO₂ capture processes, there have been intensive efforts to develop CO₂-selective solid sorbents that have high sorption capacity for CO₂ and that can be repeatedly and easily regenerated without loss of such sorption capacity, and without the high levels of regeneration energy necessary in aqueous amine solution CO₂ scrubbing processes.

In these efforts, amine-doped solid sorbents have been developed, but the solid sorbents developed to date require high temperatures for regeneration and are correspondingly susceptible to thermal degradation or alternatively have low desorption rates that render them unsuitable for commercial applications.

In consequence, there is a continuing and critical need in the art for improved CO₂ capture materials and processes that overcome the aforementioned deficiencies.

### SUMMARY

The present disclosure relates to sorbents useful for CO₂ capture, CO₂ capture systems including such sorbents, and methods for making and using such sorbents.

In one aspect, the disclosure relates to a sorbent useful for CO₂ capture, comprising a solid support with CO₂-sorbing amine and ionic liquid thereon.

In another aspect, the disclosure relates to a method of making a CO₂ capture sorbent, comprising depositing CO₂-sorbing amine and ionic liquid on a solid support.

In an additional aspect, the disclosure relates to a method of making a CO₂ capture sorbent, comprising depositing ionic liquid on a solid support having an amine thereon.

In a further aspect, the disclosure relates to a method of making a CO₂ capture sorbent, comprising:
depositing a CO₂-sorbing amine on a solid support to form an aminated support; and
   depositing ionic liquid on the aminated support to form the CO₂ capture sorbent comprising the solid support with the CO₂-sorbing amine and ionic liquid thereon.

In a further aspect, the disclosure relates to a method of CO₂ capture, comprising contacting a CO₂-containing gas with a sorbent comprising a solid support with CO₂-sorbing amine and ionic liquid thereon, to produce CO₂-reduced gas, and sorbent having CO₂ adsorbed thereon.

In yet another aspect, the disclosure relates to a CO₂ capture system comprising at least one sorption vessel containing a CO₂ capture sorbent comprising a solid support with CO₂-sorbing amine and ionic liquid thereon, wherein the vessel is arranged for contacting of CO₂-containing gas with the sorbent therein and discharge of CO₂-reduced contacted gas.

Other aspects, features and embodiments of the disclosure will be more fully apparent from the ensuing description and appended claims.

### BRIEF DESCRIPTION OF THE DRAWINGS

FIG. 1 is a graph of relative CO₂ sorbent weight (wt %), showing sorbent weight gain as a function of time and number of cycles, for catalytic ionic liquid-enhanced CO₂ sorbents of the present disclosure, and for corresponding CO₂ sorbents without ionic liquid catalyst.

FIG. 2 is a graph of first cycle relative CO₂ sorbent weight gain as a function of time, for a catalytic ionic liquid-enhanced CO₂ sorbent of the present disclosure, and for a corresponding CO₂ sorbent without ionic liquid catalyst.

FIG. 3 is a graph of percentage increase of CO₂ adsorption as a function of time, for a catalytic ionic liquid-enhanced CO₂ sorbent of the present disclosure, and for a corresponding CO₂ sorbent without ionic liquid catalyst.

FIG. 4 is a graph of increase in adsorption rate as a function of time, for a catalytic CO₂ sorbent of the present disclosure as compared to a corresponding CO₂ sorbent without ionic liquid catalyst.

FIG. 5 is a graph of relative weight of CO₂ desorbed as a function of time, for a catalytic ionic liquid-enhanced CO₂ sorbent of the present disclosure, and for a corresponding CO₂ sorbent without ionic liquid catalyst.

FIG. 6 is a graph of increase in the relative amounts of CO₂ desorbed as a function of time, for a catalytic ionic liquid-enhanced CO₂ sorbent of the present disclosure as compared to a corresponding CO₂ sorbent without ionic liquid catalyst.

FIG. 7 is a graph of increase in CO₂ desorption rate as a function of desorption time, for a catalytic ionic liquid-enhanced CO₂ sorbent of the present disclosure, in relation to a corresponding CO₂ sorbent without ionic liquid catalyst.

FIG. 8 is a graph of CO₂ breakthrough curves for a catalytic ionic liquid-enhanced CO₂ sorbent of the present disclosure as compared to a corresponding CO₂ sorbent without ionic liquid catalyst.

FIG. 9 is a graph of increase in the amounts of CO₂ desorbed as a function of time and temperature, for a catalytic ionic liquid-enhanced CO₂ sorbent of the present disclosure as compared to a corresponding CO₂ sorbent without ionic liquid catalyst.

FIG. 10 is a graph of increase in CO₂ desorption amount as a function of desorption time and temperature, for a catalytic ionic liquid-enhanced CO₂ sorbent of the present disclosure, in relation to a corresponding CO₂ sorbent without ionic liquid catalyst.

FIG. 11 is a graph of CO₂ breakthrough curves for a catalytic ionic liquid-enhanced CO₂ sorbent of the present disclosure as compared to a corresponding CO₂ sorbent without ionic liquid catalyst.

FIG. 12 is a graph of increase in the amounts of CO₂ adsorbed as a function of time, for a catalytic ionic liquid-enhanced CO₂ sorbent of the present disclosure as compared to a corresponding CO₂ sorbent without ionic liquid catalyst.

FIG. 13 is a graph of CO₂ breakthrough curves for a catalytic ionic liquid-enhanced CO₂ sorbent of the present disclosure as compared to a corresponding CO₂ sorbent without ionic liquid catalyst for several adsorption and desorption cycles.

FIG. 14 is a graph of the amounts of CO₂ adsorbed as a function of time, for a catalytic ionic liquid-enhanced CO₂ sorbent of the present disclosure as compared to a corresponding CO₂ sorbent without ionic liquid catalyst for two adsorption and desorption cycles.

FIG. 15 is a schematic representation of a multibed CO₂ capture system according to one embodiment of the present disclosure.

### DETAILED DESCRIPTION

The present disclosure relates to sorbents useful for CO₂ capture, CO₂ capture systems including such sorbents, and methods of making and using such sorbents.

It will be appreciated from the subsequent description herein that the solid CO₂ sorbents, CO₂ capture systems, and CO₂ capture methods of the present disclosure may embody and be implemented with any of a wide variety of elements, features, and arrangements, among those disclosed herein. Correspondingly, it will be appreciated that such sorbents, systems, and methods may comprise, consist, or consist essentially of any of such elements, features, and arrangements, and that any of such elements, features, and arrangements may be modified or even absent in specific implementations and applications of the present disclosure.

For example, the ionic liquids utilized in the practice of the present disclosure may be restrictively specified in various embodiments, to exclude a specific one or specific ones from among the ionic liquids herein variously disclosed. Likewise, the CO₂-sorbing amine utilized in the CO₂ capture sorbent of the present disclosure may be restrictively specified in various embodiments, to exclude a specific one or specific ones from among the CO₂-sorbing amines variously described herein.

As an example, monoethanolamine may be excluded as a CO₂-sorbing amine in various embodiments of the CO₂ capture sorbent, which are restrictively specified with regard to the particular CO₂-sorbing amines designated for such embodiments. The CO₂-sorbing amine utilized in the CO₂ capture sorbent may also be restrictively specified as to its association with the solid support, or a solid support surface thereof, as being covalently bonded to the support or support surface, being ionically bonded to the support or support surface, being impregnated in porosity of the support or support surface, being associated by van der Waals interaction with the support or support surface, and/or otherwise specifically associated with the support or support surface.

It will therefore be appreciated that the form, constitution, composition, arrangement, performance, and operation of the sorbents, systems, and methods of the present disclosure may be widely varied based on the substance and scope of the present disclosure, as implemented by persons ordinarily skilled in the art, in the field of the present disclosure.

The sorbents of the present disclosure are characterized by high CO₂ selectivity and high CO₂ capacity, and can be regenerated at temperatures below 100° C. in repeated sorption/desorption cycles, with high desorption rate and retention of high CO₂ selectivity and CO₂ capacity.

The present disclosure reflects the discovery that ionic liquids may be employed to enhance CO₂ sorption and desorption characteristics of amine-based CO₂ solid sorbents, including characteristics of sorption rate, sorption capacity, desorption rate, desorption capacity, and regeneration temperature, by catalytic action in the amine-based CO₂ solid sorbent. Ionic liquids, by virtue of their composition of inorganic cations and organic or inorganic anions, exhibit a number of favorable characteristics in the present application to amine-based CO₂ solid sorbents, including high chemical/thermal stability, tunable physiochemical characteristics (acid/base sites), low corrosivity, low heat capacity, and environmentally favorable characteristics. In accordance with the present disclosure, ionic liquids are integrated as catalytic components in amine-containing solid sorbents to achieve a new generation of CO₂ capture sorbents with significantly improved adsorption/desorption performance and regeneration temperature requirements, e.g., regeneration temperatures on the order of 70° C.-100° C.

Although it was not known or ascertainable, a priori, whether solid supports with CO₂-sorbing amine and ionic liquid thereon could or would be effective for gas/solid sorbent CO₂ capture applications, the CO₂ solid sorbents of the present disclosure have demonstrated remarkably effective CO₂ capture capability and regeneration performance, as evidenced by the empirical results more fully described hereinafter.

In various specific implementations, regeneration temperatures on the order of 70° C.-95° C. may be utilized, such as regeneration temperatures of 75° C.-90° C. The regeneration may be carried out under temperature swing desorption conditions, pressure swing desorption conditions, or a combination of temperature swing and pressure swing desorption conditions. The pressure swing desorption conditions may include vacuum desorption conditions, or desorption at any suitable (atmospheric, sub-atmospheric, or super-atmospheric) pressure that is effective to remove previously adsorbed CO₂ and regenerate the sorbent for further contacting with CO₂-containing gas.

The present disclosure thus provides a sorbent useful for CO₂ capture, comprising a solid support with CO₂-sorbing amine and ionic liquid thereon. Such CO₂ capture sorbent may be advantageously utilized in a wide variety of CO₂ removal and sequestration applications. For example, CO₂ capture applications in which the sorbent of the present disclosure can be employed to sorptively remove CO₂ from CO₂-gas mixtures include the illustrative applications listed in Table 1 below, as identified with representative CO₂ concentrations encountered in such applications.

TABLE 1
Illustrative CO₂ Capture Applications
and Representative CO₂ Concentrations

| | CO₂ Concentration | |
|---|---|---|
| Applications | in Gas Stream | |
| Coal-fired power plant flue gas | 10 to 15 | vol % |
| Natural gas combined cycle (NGCC) power plant | 3 to 5 | vol % |
| flue gas | | |
| Blast furnace exhaust gas | 17 to 21 | vol % |
| Cement plant exhaust gas | 15 to 25 | vol % |
| Natural gas fired once through steam generator | 8 to 10 | vol % |
| Integrated gasification combined cycle (IGCC) | 18 to 40 | vol % |
| syngas | | |
| Syngas from steam methane reforming | 18 to 25 | vol % |
| Steam methane reforming flue gas | 8 to 22 | vol % |
| Steam methane pressure swing adsorption tail gas | 40 to 50 | vol % |
| Syngas from biomass gasification | 9 to 25 | vol % |
| Syngas from municipal waste gasification | 20 to 30 | vol % |
| Biogas | 30 to 60 | vol % |
| Direct air capture of CO₂ | ~400 | ppmv |

In the sorbent of the present disclosure, comprising a solid support with CO₂-sorbing amine and ionic liquid thereon, the solid support may be of any suitable type and composition that is effective to support the amine and ionic liquid thereon. Illustrative solid support materials include, for example, carbon (e.g., carbon molecular sieves, activated carbon), silica, metal oxides (e.g., alumina, titania, zirconia, etc.), mixed metal oxides (multiple metal oxides combined), zeolites, aluminosilicates, metal organic frameworks (MOFs), clays (e.g., bentonite, montmorillonite, etc.), mesoporous materials, fabrics, non-woven materials, ceramic monoliths, metal monoliths, and ceramic-metal monoliths, polymers (e.g., polymeric sorbent resins such as polymethylmethacrylate, polystyrene, polystyrene-divinylbenzene, etc.), porous polymer networks, and mixtures, alloys, and combinations including any of the foregoing, but the disclosure is not limited thereto.

In specific embodiments, metal organic framework supports may be employed, such as for example: Zn₄O(BTE)(BPDC) wherein BTE is 4,4′,4″-[benzene-1,3,5-triyl-tris(ethyne-2,1-diyl)]tribenzoate, and BPDC is biphenyl-4,4′-dicarboxylate; Zn₄O(BTB)₂, wherein BTB is 1,3,5-benzenetribenzoate; Zn₄O(BBC)₂, wherein BBC is 4,4′,4″-[benzene-1,3,5-triyl-tris(benzene-4,1-diyl)]tribenzoate; Zn₄O(BDC)₃, wherein BDC is 1,4-benzenedicarboxylate; Mn₃[(Mn₄Cl)₃(BTT)₈]₂, where BTT is benzene-1,3,5-tris(1H-tetrazole); or Cu₃(BTC)₂(H₂O)₃, wherein BTC is 1,3,5-benzenetricarboxylic acid.

The CO₂-sorbing amine on the solid support likewise may be of any suitable type and composition that is effective in contact with a CO₂-containing gas mixture to remove CO₂ therefrom. CO₂-sorbing amines that may be advantageously employed in various embodiments of the present disclosure include primary, secondary, and tertiary alkylamines and alkanolamines, aromatic amines, mixed amines, polyamines, and combinations thereof. The amine is advantageously of a low volatility character wider the conditions wider which it is employed for CO₂ adsorption and desorption, and to which it is otherwise exposed, to minimize and preferably to avoid amine emissions that may contaminate the gas streams with which it is contacted, and/or reduce the effectiveness of the CO₂ sorption system over time.

By way of example, the CO₂-sorbing amine in the sorbent of the disclosure may comprise one or more amine(s) such as monoethanolamine (MEA), triethanolamine (TEA), diethanolamine (DEA), diethylenetriamine (DETA), 2-(2-aminoethylamino)ethanol, diisopropanolamine, 2-amino-2-methyl-1,3-propanediol, pentaethylenehexamine, tetramethylenepentaamine, tetraethylenepentamine (TEPA), methyldiethanolamine (MDEA), polyallylamines, aminosilanes, tetraalkoxysilanes, aminoalkylalkoxysilanes (e.g., 3-aminopropyltriethoxysilane), hyperbranched aminosilica (HAS), and polymeric amines (e.g., polyethylenimines (PEI), etc.), as well as combinations and mixtures including one or more of the foregoing, but the disclosure is not limited thereto.

In specific embodiments of the sorbent, the CO₂-sorbing amine comprises a polyalkyleneimine, e.g., polyethyleneimine or polypropyleneimine, or other suitable amine species. Polyethyleneimines are preferred in various embodiments because of their high proportion of secondary and primary amino functional groups and their low volatility. Polyethylenimines also provide a high nitrogen/carbon ratio which is advantageous for maximizing the amount of amino functional groups in the adsorbent.

In like manner, the ionic liquid in the CO₂ capture sorbent of the present disclosure may be of any suitable type and composition that is effective in the sorbent to enhance CO₂-sorption, CO₂-desorption, and/or regeneration temperature characteristics of the CO₂ capture sorbent, as compared to a corresponding CO₂ capture sorbent lacking the ionic liquid therein. Thus, for example, the ionic liquid may be an ionic liquid that is interactive with the CO₂-sorbing amine to enhance at least one of the sorbent characteristics of (i) CO₂ sorption capacity, (ii) CO₂ sorption rate, (iii) CO₂ desorption capacity, (iv) CO₂ desorption rate, and (v) regeneration temperature, in relation to a corresponding sorbent lacking the ionic liquid.

In the CO₂ capture sorbents of the present disclosure, ionic liquids enable high catalytic activity to be achieved, due to the Bronsted acid sites that are provided by the ionic liquids. As used in such context, a Bronsted acid is any substance (molecule or ion) that can donate a hydrogen ion (H⁺). The parameter pKa measures how tightly a proton is held by a Bronsted acid. A pKa value may be a small, negative number, such as −3 or −5. It may be a larger, positive number, such as 30 or 50 or more. The lower the pKa of a Bronsted acid, the more easily it gives up its proton. Common Bronsted acids include organic acids such as acetic acid, phenols, organic sulfonic acids, and thiophenols.

Ionic liquids include ionic compounds that are liquid below 100° C. Ionic liquids may have melting points below ambient room temperatures, and even below 0° C. Preferred ionic liquids in the practice of the present disclosure include ionic liquids that are liquid over a wide temperature range, e.g., 300-400° C., from their melting point to their decomposition temperature. In general, ionic liquids have low symmetry, including at least one ion having a delocalized charge and an organic component, which prevent formation of stable crystal lattice structures, and cationic charge as well as anionic charge is distributed over a relatively large volume of the molecule by resonance.

The strong ionic (coulombic) interaction within ionic liquids results in a negligible vapor pressure other than under decomposition conditions, in addition to non-flammable character, and high thermal/mechanical/electrochemical stability. Ionic liquids also provide favorable solvent properties, and exhibit immiscibility with water or organic solvents that produces biphasic phenomena. The selection of the cation in the ionic liquid will have a strong impact on its properties, including its stability. The chemistry and functionality of the ionic liquid is generally controlled by the selection of the anion.

The ionic liquid in the CO₂ capture sorbent of the present disclosure may comprise one or more than one ionic liquid(s). The ionic liquid may for example comprise one or more ionic liquid(s) selected from among ammonium, imidazolium-, phosphonium-, pyridinium-, pyrrolidinium-, and sulfonium-based ionic liquids, as an ionic liquid comprising one or more cations of the following structures

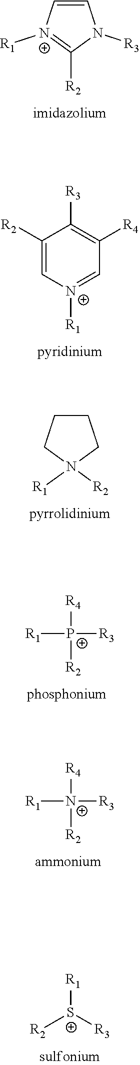

and associated organic or inorganic anions of any suitable character. In various embodiments, anions such as the following may be employed

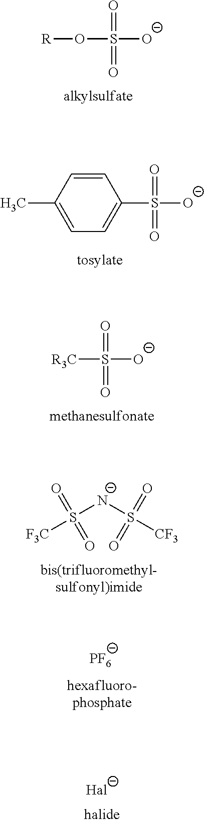

although a wide variety of other specific anions may be employed in the general practice of the present disclosure.

Illustrative ionic liquids that may be employed in various embodiments of the present disclosure include:
1-decyl-3-methylimidazolium bis(trifluoromethylsulfonyl)imide;
1-ethyl-3-methylimidazolium tetrafluoroborate;
1-ethyl-3-methylpyridinium bis(trifluoromethylsulfonyl)imide;
1-ethylpyridinium bromide;
1-hexyl-3-methylimidazolium triflate;
1,2-dimethyl-3-propylimidazolium bis(trifluoromethylsulfonyl)imide;
1,2-dimethyl-3-propylimidazolium bromide;
1,2-dimethyl-3-propylimidazolium iodide;
1,2-dimethylimidazole;
1,2-dimethylimidazolium chloride;
1,2-dimethylimidazolium bis(trifluoromethylsulfonyl)imide;
1,3-diethylimidazolium bis(trifluoromethylsulfonyl)imide;
1,3-diethylimidazolium bromide;
1,3-diethylimidazolium tetrafluoroborate;
1-(2-hydroxyethyl)-3-methylimidazolium bis(trifluoromethylsulfonyl)imide;
1-allyl-3-methylimidazolium bis(trifluoromethylsulfonyl)imide;
1-benzyl-3-methylimdiazolium 1,1,2,2-tetrafluoroethanesulfonate;
1-benzyl-3-methylimidazolium bis(trifluoromethylsulfonyl)imide;
1-butyl-1-methylpiperidinium bis(trifluoromethylsulfonyl)imide;
1-decyl-3-methylimidazolium hexafluorophosphate;
1-dodecyl-3-methylimidazolium bis(trifluoromethylsulfonyl)imide;
1-ethyl-1-methylpyrrolidinium hexafluorophosphate;
1-ethyl-3-methylimidazolium hexafluorophosphate;
1-ethyl-4-methylpyridinium bis(trifluoromethylsulfonyl)imide;
1-heptyl-3-methylimidazolium bis(trifluoromethylsulfonyl)imide;
1-hexadecyl-3-methylimidazolium hexafluorophosphate;
1-hexyl-1-methylpyrrolidinium bis(trifluoromethylsulfonyl)imide;
1-methylimidazolium bis(trifluoromethylsulfonyl)imide;
1-propyl-4-methylpyridinium bromide;
bis(1-butyl-3-methylimidazolium) tetrathiocyanatocobaltate;
diethylmethylsulfonium bis(trifluoromethylsulfonyl)imide;
trihexyltetradecylphosphonium bis(trifluoromethylsulfonyl)imide; and
triphenylcarbenium tetrakis(perfluoro-tert-butoxy) aluminate,
   but the disclosure is not limited thereto.

In particular embodiments of the present disclosure, the ionic liquid may comprise an ionic liquid of the formula:

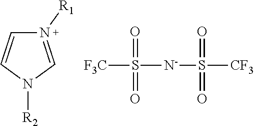

wherein each of R₁ and R₂ is independently selected from H, hydroxy, halo (F, Br, Cl, I), C₁-C₁₂ alkyl, C₁-C₁₂ alkoxy, C₁-C₁₂ carboxy, C₁-C₁₂ haloalkyl, C₆-C₁₂ aryl, C₆-C₁₄ arylalkyl, C₅-C₁₀ cycloalkyl, amino or substituted amino, thiol, phosphate, sulfate, phosphonate, and sulfonate. In particular embodiments, each of R₁ and R₂ is independently selected from C₁-C₁₂ alkyl.

In still other embodiments, the ionic liquid may comprise an ionic liquid selected from the group consisting of 1-ethyl-3-methylimidazolium bis(trifluoromethylsulfonyl)imide, 1-butyl-3-methylimidazolium bis(trifluoromethylsulfonyl)imide, 1-ethyl-2,3-dimethylimidazolium bis(trifluoromethylsulfonyl)imide, 1-butyl-3-methylimidazolium trifluoromethanesulfonate, 1-butyl-2,3-methylimidazolium bis(trifluoromethylsulfonyl)imide, and 1-methyl acetyl, 3-methylimidazolium bis(trifluoro methyl sulfonyl)imide.

The ionic liquid in specific embodiments may include a substituted imidazolium group and a bis(trifluoromethylsulfonyl)imide group, wherein substituents of the substituted imidazolium group or of any suitable character for the particular application involved.

The ionic liquid may be present in any suitable concentration in the sorbent, which is effective to enhance the sorption and/or desorption characteristics and/or regeneration temperature characteristics thereof. In various embodiments, the ionic liquid may be present in the sorbent at concentration of from 1 to 5000 ppm by weight, based on total weight of the amine present on the sorbent. In other embodiments, the ionic liquid may be present in the sorbent at concentration of from 1 to 1000 ppm by weight, based on total weight of the amine present on the sorbent. In still other embodiments, the ionic liquid may be present in the sorbent at concentration of from 1 to 100 ppm by weight, based on total weight of the amine present on the sorbent. It will be appreciated that the concentration of the ionic liquid may be widely varied in the practice of the present disclosure.

The use of ionic liquids in the CO₂ capture sorbents of the present disclosure enables the regeneration temperatures of the sorbent to be substantially reduced, as compared to a corresponding sorbent lacking the ionic liquid. This in turn imparts higher stability to the sorbent and achieves lower amine emissions from the sorbent, as compared to a corresponding sorbent lacking the ionic liquid and therefore requiring higher temperature regeneration, e.g., at temperatures significantly above 100° C. The lower regeneration temperature also enables utilization of lower grade heat sources such as waste heat from process plants, power plants, and other facilities.

A further advantage of the ionic liquid catalyzed CO₂ capture sorbents of the present disclosure as a consequence of their lowered regeneration temperatures is that water that is sorbed or otherwise present on the sorbent is not desorbed or otherwise volatilized at the lowered regeneration temperatures. Accordingly, the overall energy required for regeneration is reduced, and CO₂ capture costs are correspondingly lowered.

The CO₂ capture sorbent of the present disclosure may be provided in any suitable conformation that is efficacious for CO₂ capture from CO₂-containing gas contacted with the sorbent. For example, the solid support may be of any suitable size and/or shape, or combination of suitable sizes and/or shapes, and the amine and ionic liquid thereon may be doped, deposited, impregnated, consolidated or otherwise integrated with the solid support in any suitable manner. Further, the CO₂ capture sorbent of the present disclosure may be combined with other sorbents, structures, components, agents, ingredients, etc. that further enhance the overall CO₂ capture that is achieved, or that provide suitable sorptive action and sorption capacity, or other removal capacity, for other constituents of the CO₂-containing gas that are desirably removed in the processing of such gas. For example, the CO₂ capture sorbent of the present disclosure may be provided as a part of a laminated composite sorbent including a sorbent for nitrogenous gas species, hydrocarbon species, and/or other components of the CO₂-containing gas.

The solid CO₂ capture sorbent of the present disclosure thus may comprise a solid support that is in any suitable form. The solid support may for example be in the form of particles, of geometrically regular or irregular shape, such as spherical, spheroidal, oblate, lobular, multi-lobular, or other forms or conformations of particles, in any suitable particle sizes and/or particle size distributions. Alternatively, the solid support may be in the form of platelets, flakes, films, sheets, discs, rods, fibers, filaments, rings, blocks, monoliths, parallelepipeds, composites, laminates, or in any other suitable forms, in any suitable sizes and/or size distributions. The solid support in various embodiments may be porous, non-porous, foraminous, channelized, or may be otherwise configured to provide appropriate surface and/or volume to accommodate desired amounts of CO₂-sorbing amine and ionic liquid thereon.

By way of non-limiting illustrative examples, the solid support in various specific embodiments may be in the form of particles having a size in a range of from 2 μm to 50 mm, or particles having a size in a range of from 50 nm to 1 μm, or particles having a size in a range of from 100 nm to 10 mm, although the disclosure is not limited thereto and ranges including other lower and/or upper end point values, or other size dimensions, may be employed in specific applications, as necessary or desirable therein.

In another aspect, the disclosure relates to a method of making a CO₂ capture sorbent, comprising depositing CO₂-sorbing amine and ionic liquid on a solid support.

In an additional aspect, the disclosure relates to a method of making a CO₂ capture sorbent, comprising depositing ionic liquid on a solid support having an amine thereon.

The present disclosure in another aspect relates to a method of making a CO₂ capture sorbent, comprising:
depositing a CO₂-sorbing amine on a solid support, to form an aminated support; and depositing ionic liquid on the aminated support to form the CO₂ capture sorbent comprising the solid support with the CO₂-sorbing amine and ionic liquid thereon.

In such method, the depositing of ionic liquid on the aminated support may comprise contacting the aminated support with an alkanolic solution of the ionic liquid to impregnate the aminated support with the ionic liquid, recovering the ionic liquid-impregnated aminated support from the alkanolic solution, and removing alkanol from the recovered ionic liquid-impregnated aminated support to yield the CO₂ capture sorbent comprising the solid support with the CO₂-sorbing amine and ionic liquid thereon. The removal of the alkanol from the recovered ionic liquid-impregnated aminated support may be carried out in any suitable manner, and may for example comprise evaporating the alkanol from the recovered ionic liquid-impregnated aminated support, by any suitable volatilization technique or procedure.

The disclosure in a further aspect relates to a method of CO₂ capture, comprising contacting a CO₂-containing gas with a sorbent comprising a solid support with CO₂-sorbing amine and ionic liquid thereon, to produce CO₂-reduced gas, and sorbent having CO₂ adsorbed thereon.

Such CO₂ capture method may in specific embodiments further comprise regenerating the sorbent having CO₂ adsorbed thereon, to desorb CO₂ therefrom to form regenerated sorbent, and CO₂ desorbate; and recovering the CO₂ desorbate from the regenerated sorbent.

In specific embodiments, the foregoing CO₂ capture method may be conducted in a multi-bed system comprising multiple beds of the sorbent arranged for continuous CO₂ capture processing of the CO₂-containing gas, wherein one or more of the multiple beds is on-stream for said contacting of the CO₂-containing gas with the sorbent, and another or others of the multiple beds is off-stream and while off-stream said regenerating and recovering are carried out, with each of the multiple beds undergoing sequential on-stream and off-stream operations in a cyclic repeating sequence for said continuous CO₂ capture processing of the CO₂-containing gas. The multi-bed system may be a pressure-swing adsorption (PSA) multi-bed system, or a thermal-swing adsorption (TSA) multi-bed system, or a pressure-swing adsorption/thermal-swing adsorption (PSA/TSA) multi-bed system.

In specific embodiments, the CO₂ capture method of the disclosure may be carried out wherein the CO₂-containing gas is air, e.g., atmospheric air, in a direct air capture application, or the CO₂-containing gas may be supplied from a combustion process, e.g., wherein the CO₂-containing gas comprises effluent from an electrical power-generating plant or other CO₂-containing gas resulting from combustion of fossil fuel, syngas from organic matter gasification, blast furnace exhaust gas from steel making, cement kiln exhaust gas, effluent from a motive vehicle, etc.

In other embodiments, wherein the CO₂-containing gas is supplied from an oxidation process, such as a biological oxidation process, or other process in which oxidative action or chemical reaction is conducted.

In various other embodiments, the CO₂-containing gas may comprise one or more of: coal-fired power plant flue gas;
natural gas combined cycle power plant flue gas;
blast furnace exhaust gas;
cement plant exhaust gas;
natural gas fired once through steam generator gas;
steam methane reformer syngas;
steam methane reformer flue gas;
steam methane reformer PSA tail gas;
dry reforming syngas;
integrated gasification combined cycle (IGCC) syngas;
biogas;
biomass gasification syngas;
municipal waste gasification syngas; and
atmospheric gas.

The disclosure in yet another aspect relates to a CO₂ capture system comprising at least one sorption vessel containing a CO₂ capture sorbent comprising a solid support with CO₂-sorbing amine and ionic liquid thereon, wherein the vessel is arranged for contacting of CO₂-containing gas with the sorbent therein and discharge of CO₂-reduced contacted gas.

In such CO₂ capture system, the vessel in various embodiments may be constituted and arranged for regeneration of the sorbent after at least partial loading of CO₂ thereon resulting from said contacting. In various embodiments, the system may comprise multiple sorption vessels constituted and arranged for cyclic repeating operation comprising adsorption operation and desorption regeneration operation, e.g., for thermal swing operation, for pressure swing operation, e.g., pressure/vacuum swing operation, or for combined thermal swing and pressure swing operation, e.g., thermal swing and pressure/vacuum swing operation.

The advantages and features of the disclosure are further illustrated with reference to the following examples, which are not to be construed as in any way limiting the scope of the disclosure but rather as illustrative of various embodiments thereof in specific applications thereof.

### Example 1

0.005 wt % (50 ppmw) ionic liquid was added to an amine-doped silica sorbent by dissolving the ionic liquid (IL) in an alcohol solvent and immersing the solvent in the ionic liquid/alcohol solution for several hours. The alcohol solvent was then evaporated in a Rotavapor® rotary evaporator (BUCHI Corporation, New Castle, Delaware, USA) to remove all of the solvent. The resulting IL-treated amine-doped silica sorbent after evaporation of all solvent was tested for CO₂ adsorption and desorption capacity as a function of time, against corresponding amine-doped silica sorbent without IL treatment.

The tests were performed with a feed gas containing 10% CO₂ and 90% N₂. The test conditions were as follows:
adsorption conditions: 10% CO₂, 90% N₂, 60 mL per minute, 30° C., 20 minutes; and
desorption conditions: N₂, 60 mL per minute, 10 minutes, 85° C.

The feed gas contained trace water. In practice, water is present in flue gas, air, and many other CO₂-containing gases. The presence of water improves formation of bicarbonates and enhances adsorption and desorption rates.

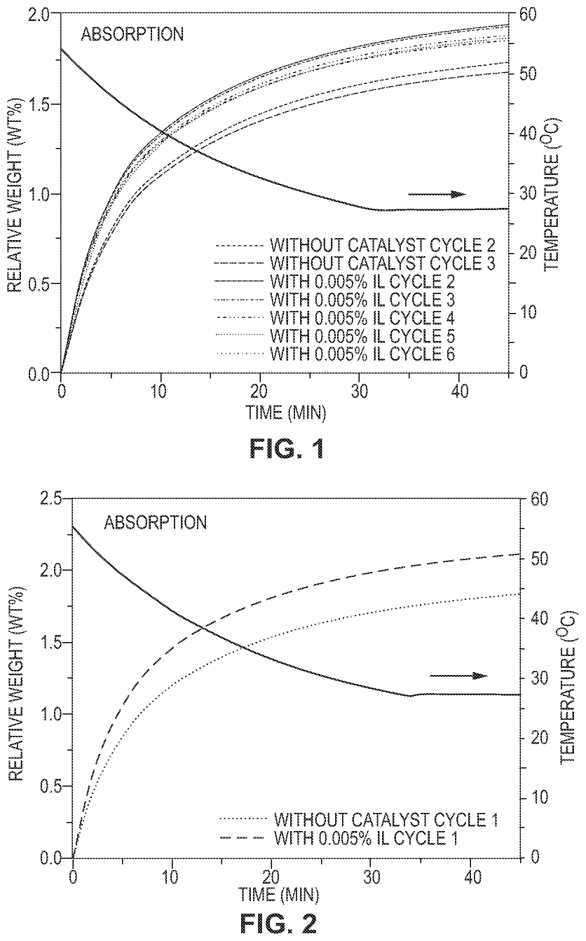

Empirical results of the testing are shown in FIGS. 1-7.

FIGS. 1-3 show sorption performance of the CO₂ sorbent of the present disclosure, comprising silica-supported amine and catalytic ionic liquid, and the sorption performance of corresponding silica-supported amine without catalytic ionic liquid (denoted as “without catalyst”).

FIG. 1 is a graph of relative CO₂ sorbent weight (wt %), showing sorbent weight gain as a function of time and number of cycles, for cycles 2, 3, 4, 5, and 6, for the ionic liquid catalyst-enhanced CO₂ sorbent of the present disclosure, and for sorbent weight gain as a function of time and number of cycles, for cycles 2 and 3, for the corresponding CO₂ sorbent without ionic liquid catalyst. The data in FIG. 1 clearly show that the CO₂ adsorption rate and CO₂ capacity were increased by addition of ionic liquid catalyst.

FIG. 2 is a graph of first cycle relative CO₂ sorbent weight gain as a function of time, for a catalytic CO₂ sorbent of the present disclosure (catalytic ionic liquid-enhanced supported amine sorbent), and for a corresponding CO₂ sorbent without ionic liquid catalyst.

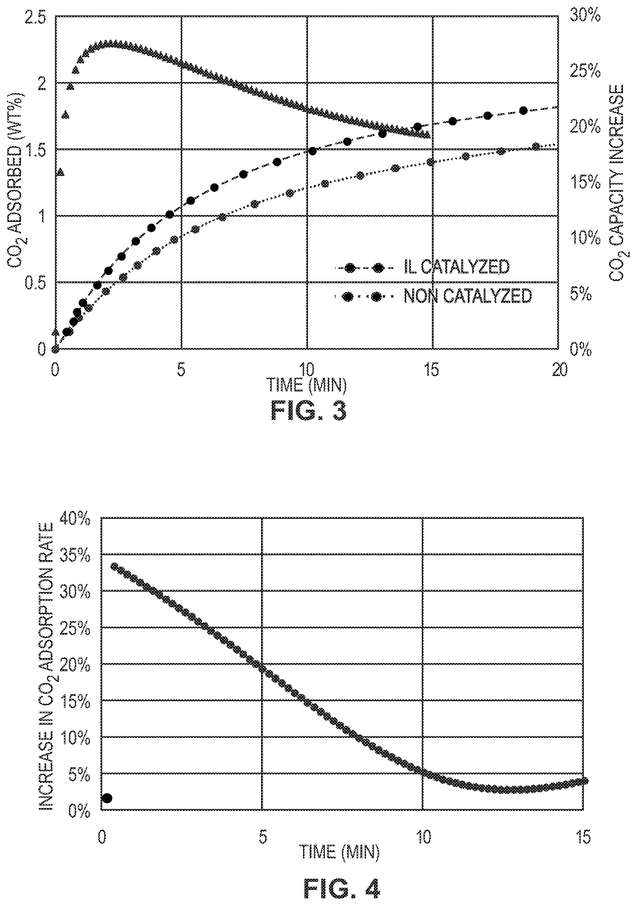

FIG. 3 is a graph of percentage increase of CO₂ adsorption as a function of time, for a catalytic ionic liquid-enhanced CO₂ sorbent of the present disclosure, and for a corresponding CO₂ sorbent without ionic liquid catalyst.

The data in FIGS. 2 and 3 for the adsorption rate and capacity of the respective sorbents (catalytic ionic liquid-enhanced CO₂ sorbent of the present disclosure, and corresponding sorbent without ionic liquid) in the first cycle of adsorption and desorption show that there is at least a 20% increase in adsorption capacity with the addition of only 50 ppm ionic liquid. For a rapid cycles sorption system, the adsorption cycle is generally less than 10 minutes, and more typically on the order of 5 minutes, in duration. After 5 minutes of the adsorption cycle, the increase in CO₂ capacity is about 27% for the catalytic ionic liquid-enhanced CO₂ sorbent of the present disclosure, in relation to the corresponding sorbent without ionic liquid.

CO₂ adsorption rate can be obtained as a derivative of the adsorption capacity. FIG. 4 is a graph of the increase in adsorption rate as a function of time, for a catalytic ionic liquid-enhanced CO₂ sorbent of the present disclosure, as compared to a corresponding CO₂ sorbent without ionic liquid catalyst. The data in FIG. 4 show that the adsorption rate increase is close to 34% at the start of adsorption and decreases with time to about 5% after 10 minutes of adsorption operation.

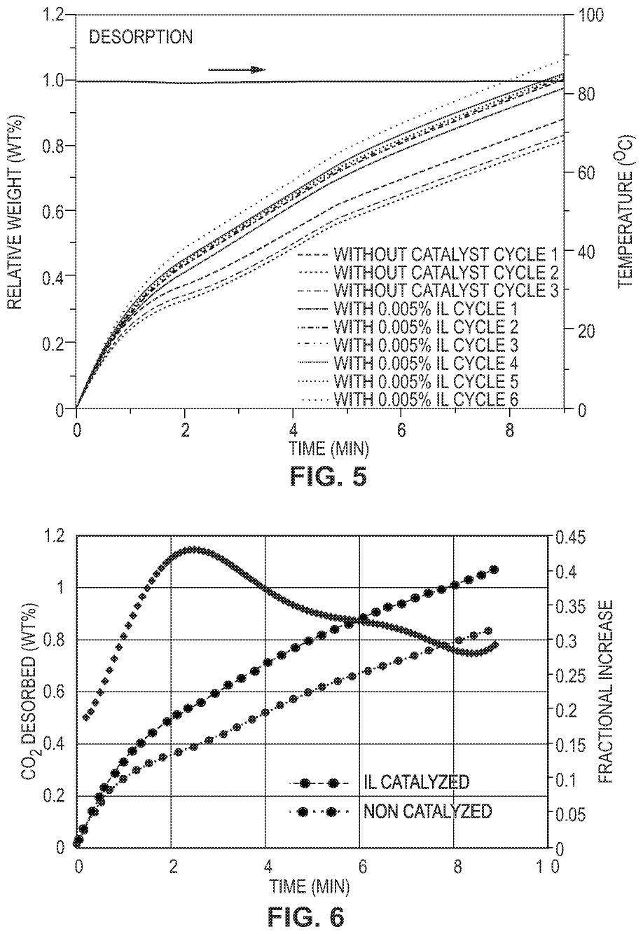

Desorption performance of the CO₂ sorbent of the present disclosure, comprising silica-supported amine and catalytic ionic liquid, and desorption performance of corresponding silica-supported amine without catalytic ionic liquid (denoted as “without catalyst”) are shown in FIGS. 5-7.

FIG. 5 is a graph of relative weight of CO₂ desorbed as a function of time, for a catalytic ionic liquid-enhanced CO₂ sorbent of the present disclosure, in desorption cycles 1, 2, 3, 4, 5, and 6, and for a corresponding CO₂ sorbent without ionic liquid catalyst, in desorption cycles 1, 2, and 3.

FIG. 6 is a graph of increase in the relative amounts of CO₂ desorbed as a function of time, for a catalytic ionic liquid-enhanced CO₂ sorbent of the present disclosure as compared to a corresponding CO₂ sorbent without ionic liquid catalyst.

As shown by the data in FIGS. 5 and 6, the desorption capacity increase for a catalytic ionic liquid-enhanced CO₂ sorbent of the present disclosure, as compared to a corresponding CO₂ sorbent without ionic liquid catalyst, is generally about 30% at desorption cycle times of less than 10 minutes.

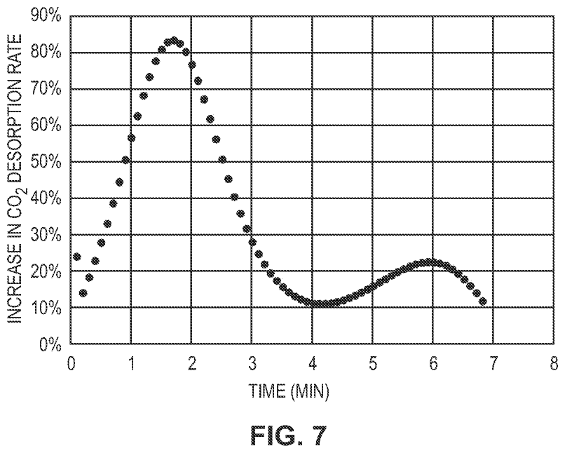

FIG. 7 is a graph of increase in CO₂ desorption rate as a function of desorption time, for a catalytic ionic liquid-enhanced CO₂ sorbent of the present disclosure, in relation to a corresponding CO₂ sorbent without ionic liquid catalyst.

The data in FIG. 7 show that the desorption increase can be as high as 82% after about 1.75 minutes of the desorption cycle, and drop to a low of 10% increase at 4 minutes of the desorption cycle.

### Example 2

0.001 wt % (10 ppmw) ionic liquid was added to a second amine-doped silica sorbent by dissolving the ionic liquid (IL) in an alcohol solvent and immersing the solvent in the ionic liquid/alcohol solution for several hours. The alcohol solvent was then evaporated in a Rotavapor® rotary evaporator (BUCHI Corporation, New Castle, Delaware, USA) to remove all of the solvent. The resulting IL-treated amine-doped silica sorbent after evaporation of all solvent was tested for CO₂ adsorption and desorption capacity as a function of time, against corresponding amine-doped silica sorbent without IL treatment.

The tests were performed with a feed gas containing 4% CO₂, 10% water vapor, and 86% N₂. The test conditions were as follows:
Adsorption conditions: 4% CO₂, 10% water vapor, and 86% N₂, 50 mL per minute, 45° C.; and
Desorption conditions: N₂, 600 mL per minute, 40 to 130° C.

The feed gas was nearly saturated with water. In practice, water is present in flue gas, air, and many other CO₂-containing gases. The presence of water improves formation of bicarbonates and enhances adsorption and desorption rates.

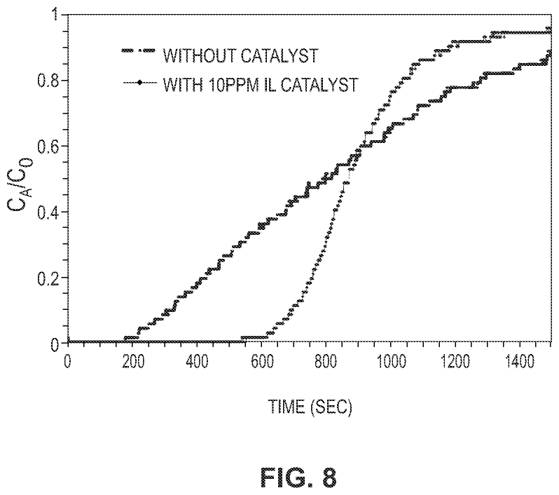

Empirical results of the testing are shown in FIGS. 8-10.

FIG. 8 shows sorption performance of the CO₂ sorbent of the present disclosure, comprising silica-supported amine and catalytic ionic liquid, and the sorption performance of corresponding silica-supported amine without catalytic ionic liquid (denoted as “without catalyst”).

FIG. 8 shows the adsorption breakthrough curves for the amine doped silica sorbent with and without the ionic liquid catalyst. These results show that the catalyzed sorbent breakthrough time was almost three times longer than the uncatalyzed sorbent with almost complete removal of CO₂ from the flue gas. The sharper breakthrough curve for the ionic liquid catalyzed sorbent means that the process using this sorbent will have much improved CO₂ capture and increased volumetric productivity by shortening the total cycle time.

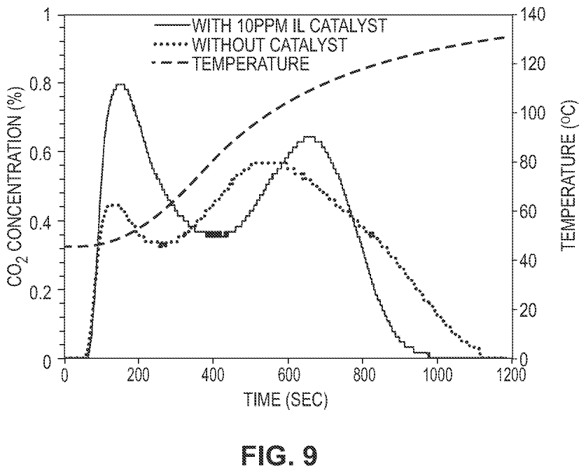

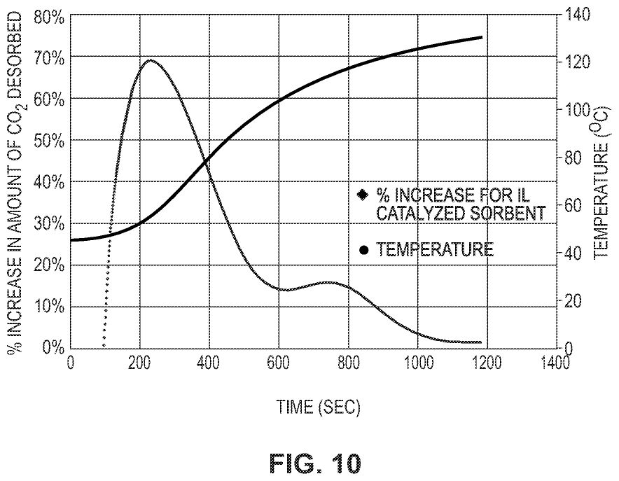

FIGS. 9 and 10 are graphs of desorption measurements carried out from 45 to 130° C. for the amine doped silica sorbent with and without the ionic liquid catalyst.

FIG. 9 is a graph of desorbed stream CO₂ concentration as a function of time and temperature for the catalytic ionic liquid-enhanced CO₂ amine doped silica sorbent of the present disclosure, and for the corresponding CO₂ amine doped silica sorbent without ionic liquid catalyst. FIG. 10 is a graph of increase in CO₂ desorption amount as a function of desorption time and temperature, for the catalytic ionic liquid-enhanced CO₂ amine doped silica sorbent of the present disclosure, in relation to the corresponding CO₂ sorbent without ionic liquid catalyst.

The data in FIGS. 9 and 10 show that the catalyzed sorbent has much higher amount of CO₂ desorbed than the uncatalyzed sorbent during first 200 sec. FIG. 10, in the graph of the increase in the amount of CO₂ desorbed in comparison with the uncatalyzed sorbent, clearly shows that the amount of CO₂ desorbed increases as much as 70% during the first 200 sec. This increase will be even higher when the desorption takes place at higher and constant temperatures for the catalytic CO₂ sorbent of the present disclosure (catalytic ionic liquid-enhanced supported amine sorbent) and the corresponding sorbent without ionic liquid.

### Example 3

0.01 wt % (100 ppmw) ionic liquid was added to a second amine-doped silica sorbent by dissolving the ionic liquid (IL) in an alcohol solvent and immersing the solvent in the ionic liquid/alcohol solution for several hours. The alcohol solvent was then evaporated in a Rotavapor® rotary evaporator (BUCHI Corporation, New Castle, Delaware, USA) to remove all of the solvent. The resulting IL-treated amine-doped silica sorbent after evaporation of all solvent was tested for CO₂ adsorption breakthrough and capacity as a function of time, against corresponding amine-doped silica sorbent without IL treatment, for direct capture of CO₂ from air.

The tests were performed with a feed air stream containing 400 ppmv CO₂ and at 60% relative humidity. The test conditions included the following:
Adsorption conditions: 500 mL per minute, 25° C.

The feed gas was humidified to 60% relative humidity. In practice, water is present in flue gas, air, and many other CO₂-containing gases. The presence of water improves formation of bicarbonates and enhances adsorption and desorption rates.

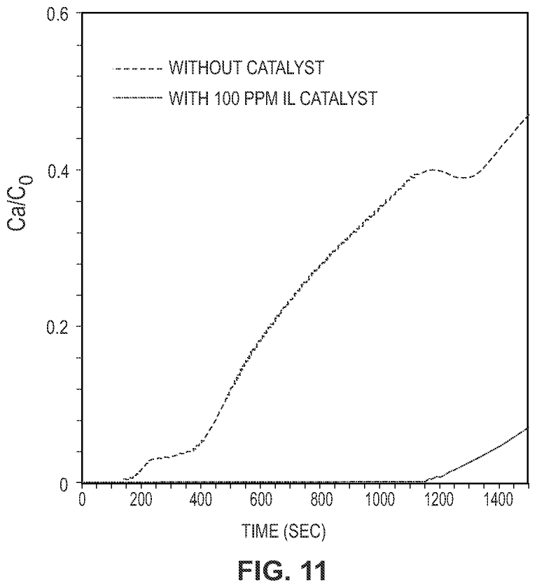

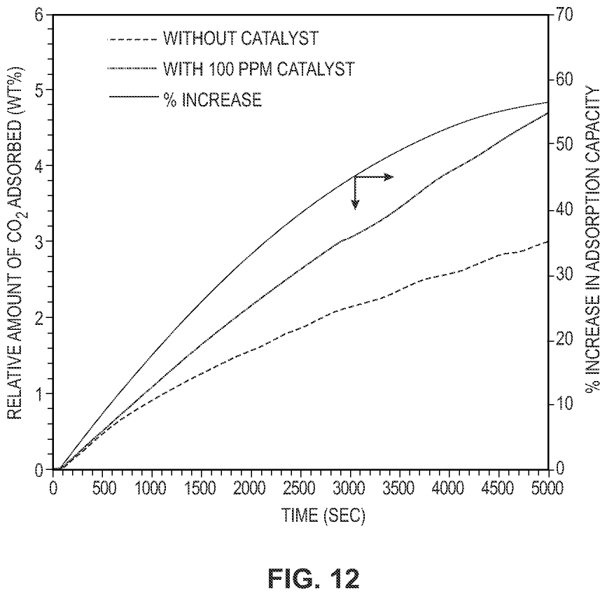

Empirical results of the testing are shown in FIGS. 11-12.

FIG. 11 shows sorption performance of the CO₂ sorbent of the present disclosure, comprising silica-supported amine and catalytic ionic liquid, and the sorption performance of corresponding silica-supported amine without catalytic ionic liquid (denoted as “without catalyst”), in adsorption breakthrough curves for the amine doped silica sorbent with and without the ionic liquid catalyst. These results show that the catalyzed sorbent breakthrough time is almost six to seven times longer than the uncatalyzed sorbent, with almost complete removal of CO₂ from air prior to breakthrough.

FIG. 12 is a graph of relative CO₂ sorbent weight gain as a function of time, for a catalytic CO₂ sorbent of the present disclosure (catalytic ionic liquid-enhanced supported amine sorbent), and for a corresponding CO₂ sorbent without ionic liquid catalyst.

The data in FIG. 12 for the adsorption capacity of the respective sorbents (catalytic ionic liquid-enhanced CO₂ sorbent of the present disclosure, and corresponding sorbent without ionic liquid) show that there was up to 55% increase in adsorption capacity with the addition of 100 ppm ionic liquid.

### Example 4

0.01 wt % (100 ppmw) ionic liquid was added to a third amine-doped silica sorbent by dissolving the ionic liquid (IL) in an alcohol solvent and immersing the solvent in the ionic liquid/alcohol solution for several hours. The alcohol solvent was then evaporated in a Rotavapor® rotary evaporator (BUCHI Corporation, New Castle, Delaware, USA) to remove all of the solvent. The resulting IL-treated amine-doped silica sorbent after evaporation of all solvent was tested for CO₂ adsorption breakthrough and capacity as a function of time, against corresponding amine-doped silica sorbent without IL treatment, for direct capture of CO₂ from air.

The tests were performed with a feed air stream containing 400 ppmv CO₂ and at 60% relative humidity. The test conditions were as follows:
Adsorption conditions: gas flow rate 500 mL/min; absorption temperature: 25° C.
Desorption temperature: N₂, 600 mL per minute, 110° C.

The feed gas was humidified to 60% relative humidity at 20° C. In practice, water is present in flue gas, air, and many other CO₂-containing gases. The presence of water improves formation of bicarbonates and enhances adsorption and desorption rates.

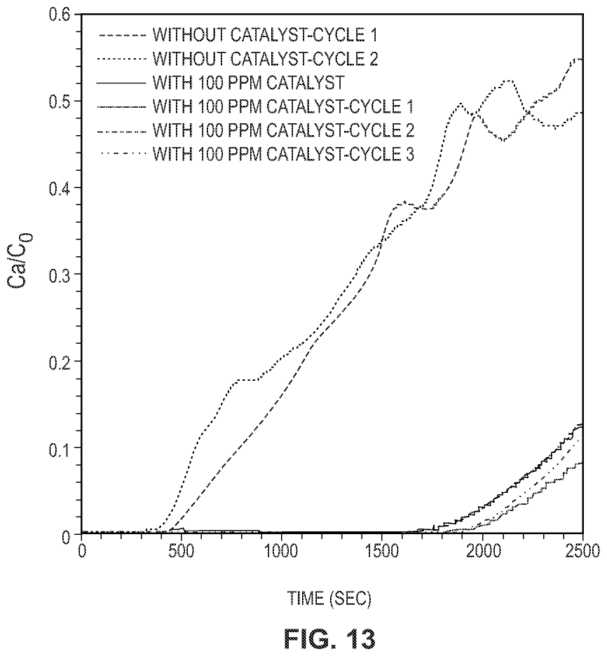

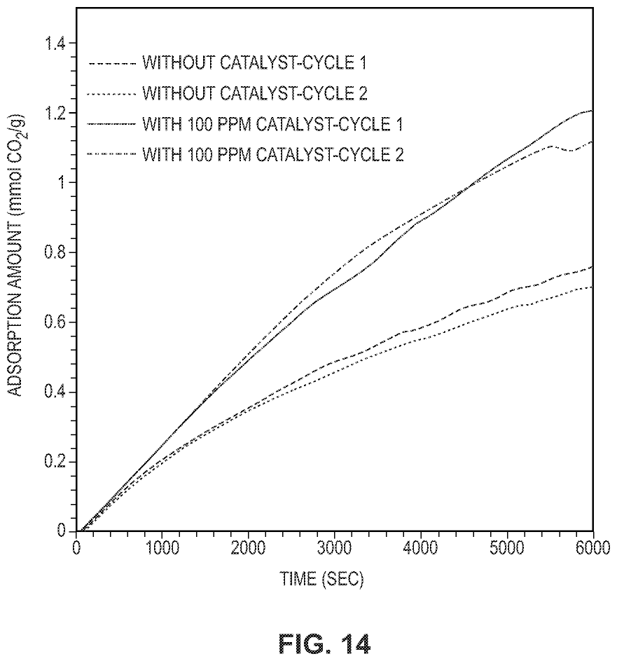

Empirical results of the testing are shown in FIGS. 13-14.

FIG. 13 shows three cycles of sorption performance of the CO₂ sorbent of the present disclosure, comprising silica-supported amine and catalytic ionic liquid, and the sorption performance of corresponding two cycles of silica-supported amine without catalytic ionic liquid (denoted as “without catalyst”), in adsorption breakthrough curves for the amine doped silica sorbent with and without the ionic liquid catalyst. These results show that the catalyzed sorbent breakthrough time is almost four to five times longer than the uncatalyzed sorbent, with almost complete removal of CO₂ from air prior to breakthrough.

FIG. 14 is a graph of relative CO₂ sorbent weight gain in two cycles as a function of time, for a catalytic CO₂ sorbent of the present disclosure (catalytic ionic liquid-enhanced supported amine sorbent), and for a corresponding CO₂ sorbent without ionic liquid catalyst.

The data in FIG. 14 for the adsorption capacity of the respective sorbents (catalytic ionic liquid-enhanced CO₂ sorbent of the present disclosure, and corresponding sorbent without ionic liquid) show that there was up to 50% increase in adsorption capacity with the addition of 100 ppm ionic liquid.

The data and results of the foregoing Examples demonstrate the superior sorption performance of the CO₂ sorbents of the present disclosure. Such sorbents may be utilized in any of a broad spectrum of systems and equipment configurations to achieve high efficiency removal of CO₂ from CO₂-containing gases of varied compositions from a wide variety of gas sources.

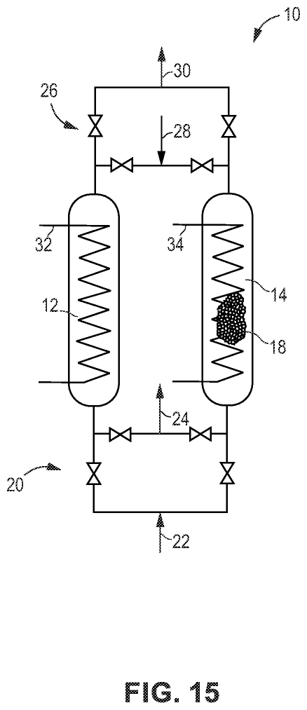

FIG. 15 is a schematic representation of a CO₂ capture system in which the CO₂ capture sorbent of the present disclosure is illustratively employed.

The CO₂ capture system 10 shown in FIG. 15 includes two sorption vessels 12 and 14. Each of these sorption vessels contains a bed of CO₂ capture sorbent 18 as depicted in the partial break-away view of sorption vessel 14. The sorption vessels 12 and 14 are manifolded to one another by the valved inlet manifold 20, including CO₂-containing gas supply conduit 22, and regeneration gas discharge conduit 24 for discharging regeneration gas after countercurrent flow through the off-stream one of the sorption vessels, while CO₂-containing gas is flowed through the other on-stream one of the sorption vessels to contact the CO₂ capture sorbent, and effect removal of CO₂ from such gas, producing a CO₂-reduced gas effluent.

The CO₂-reduced gas flows into the valved discharge manifold 26, and is discharged from the CO₂ capture system in effluent line 30. The valved discharge manifold 26 contains regeneration gas feed line 28, through which regeneration gas is introduced to the sorption vessel system for countercurrent flow through the off-stream one of the respective sorption vessels, to desorb previously sorbed CO₂ from the CO₂ capture sorbent being regenerated, thereby producing a CO₂ desorbate-containing regeneration effluent gas that is discharged from system in regeneration gas discharge line 24.

The CO₂ desorbate-containing regeneration effluent gas discharged in line 24 may then be further processed, e.g., for separation of CO₂ from the regeneration gas, with the separated CO₂ being utilized as a raw material, or sent to carbon sequestration facilities or other disposition or end use. The regeneration gas from which CO₂ has been removed may then be recycled to the process for renewed utilization as fresh or makeup regeneration gas, or may be sent to other processing or disposition.

By appropriate opening and closure of respective valves in the inlet and outlet manifolds of the CO₂ capture system, CO₂-containing gas is processed in the on-stream one of the respective sorption vessels, while the other, during such on-stream operation of the first vessel, undergoes regeneration to remove CO₂ previously adsorbed on the CO₂ capture sorbent in the adsorber during active on-stream operation, or may be on post-regeneration standby status in the cyclic operation, awaiting resumption of active onstream processing of CO₂-containing gas. Accordingly, in this arrangement, each of the respective adsorber vessels goes through cyclic alternating on-stream and off-stream operation, in respective segments of the process cycle.

Sorption vessels 12 and 14 in the FIG. 15 embodiment may be additionally equipped with heating elements 32 and 34, which can be of any suitable type. For example, such elements may be electrical resistive elements that are coupled with an electrical energy source, so that electrical current flowing through the heating elements causes them to resistively heat to elevated temperature. Such heating elements thereby transfer heat to the CO₂ capture sorbent in the sorption vessel undergoing regeneration, so that the CO₂ capture sorbent which is at least partially loaded with sorbed CO₂ thereon is correspondingly heated to effect desorption of CO₂ from the CO₂ capture sorbent in the sorption vessel. The resulting desorbed CO₂ flows out of the bed being regenerated, and is discharged in regeneration gas discharge line 24.

Alternatively, the heating elements 32 and 34 instead of including electrical resistive elements may comprise heat exchange fluid passages, through which a suitable heating fluid is passed during the sorption bed regeneration operation, so that heat flows to the CO₂ capture sorbent in the sorption vessel, to effect desorption of previously adsorbed CO₂. After such thermal swing operation has continued to a predetermined extent of removal of CO₂ from the CO₂ capture sorbent being regenerated, the flow of heating fluid through the heat exchange passages in the sorption vessel is discontinued. At that point, a cooling fluid may be passed through the sorption vessel, to reduce the temperature of the CO₂ capture sorbent therein to below the temperature utilized in the heating step, so that the CO₂ capture sorbent thereby is renewed for subsequent continued processing of CO₂-containing gas, when the regenerated sorption vessel is returned to active onstream operation.

It will be apparent from the foregoing description that the regeneration of the CO₂ capture sorbent to remove previously sorbed CO₂ therefrom may be carried out in various manners. For example, the previously sorbed CO₂ may be desorbed from the at least partially CO₂-loaded CO₂ capture sorbent solely by heating of the sorbent, or solely by differential pressure (pressure swing) operation in which sorption is conducted at higher pressure and desorption is conducted at a lower pressure (e.g., a “blowdown” release of the CO₂ sorbate from the sorbent at a super-atmospheric, atmospheric, or sub-atmospheric pressure that is lower than the higher pressure at which sorption is carried out), or solely by passage of a regeneration gas through the bed of CO₂-loaded sorbent so that sorbent/regeneration gas contacting is carried out to provide a concentration gradient producing desorption of CO₂ from the sorbent, or the regeneration of the sorbent may be carried out with combinations of the foregoing regeneration approaches, such as use of heated regeneration gas, or use of sequential thermal swing and pressure swing desorption steps, or any other operational regeneration modalities that may be effective to renew the sorbent for renewed sorption of CO₂ from CO₂-containing gas.

Regeneration gases that may be utilized in the broad practice of the present disclosure to effect desorption of previously sorbed CO₂ from the CO₂ capture sorbent may be of any suitable type, and may for example include inert gases such as nitrogen, helium, krypton, argon, and the like, or any other gas or gases that may be efficacious in regeneration of the sorbent.

Although the CO₂ capture system illustratively shown in FIG. 15 is depicted as a two-vessel system, it will be appreciated that 3 or more beds could alternatively be used, wherein at least one of such beds is at all times onstream in active CO₂ capture operation, and others thereof are in regeneration or standby modes, so that each of the multiple beds undergoes cyclic repeating operation including onstream operation for sorption of CO₂ from CO₂-containing gas, and regeneration operation including desorption of previously adsorbed CO₂ from the sorbent subsequent to the onstream CO₂ capture operation.

As a still further alternative, the CO₂ capture system may comprise only a single sorption vessel that is operated in a batch operation manner, in sequential onstream sorption and offstream desorption operational modes.

Although the CO₂ capture system has been illustratively described above with respect to a multibed system of fixed bed vessels containing the CO₂ capture sorbent of the present disclosure, it will be appreciated that the disclosure is not limited thereto, and that the CO₂ capture sorbent may be deployed in a wide variety of other CO₂-containing gas/sorbent contacting implementations, including, without limitation, moving beds, such as for example conveyor belt beds having the CO₂ capture sorbent disposed thereon, fluidized beds in which the CO₂ capture sorbent is fluidized by the CO₂-containing gas, rotating bed reactors such as for example rotating heat exchanger reactors, etc.

It will therefore be appreciated that the CO₂ capture system of the present disclosure may be widely varied in arrangement, components, and operation, to effectively utilize the CO₂ capture sorbent of the disclosure for CO₂ abatement, recovery, and disposition, in application to a wide variety of CO₂-containing gases from a correspondingly varied spectrum of CO₂-containing gas origins.

The solid CO₂ capture sorbents of the present disclosure, comprising solid supports with CO₂-sorbing amine and ionic liquid thereon, achieve a fundamental advance in the art over conventional aqueous amine solution contacting of CO₂-containing gas, obviating the issues and deficiencies associated with such aqueous amine solution contacting, e.g., with aqueous monoethanolamine solutions. The solid CO₂ capture sorbents of the present disclosure enable gas phase contacting of CO₂-containing gas with the solid CO₂ capture sorbent to be carried out in a wide variety of process and apparatus implementations.

Accordingly, the disclosure in various aspects contemplates a sorbent useful for CO₂ capture, comprising a solid support with CO₂-sorbing amine and ionic liquid thereon, and such sorbent may optionally include any one or more of the following features: (1) the solid support comprising one or more material(s) selected from the group consisting of: carbon, silica, porous silicon, zeolites, metal oxides, mixed metal oxides, aluminosilicates, metal organic frameworks (MOFs), clays, mesoporous materials, fabrics, non-woven materials, ceramic monoliths, metal monoliths, ceramic-metal monoliths, polymers, porous polymer networks, and mixtures, alloys, and combinations including any one or more of the foregoing; (2) the solid support comprising silica, alumina, zirconia, or titania; (3) the solid support comprising silica; (4) the solid support comprises one or more metal organic frameworks (MOFs); (5) the one or more MOFs comprising at least one selected from the group consisting of: Zn₄O(BTE)(BPDC) wherein BTE is 4,4′,4″-[benzene-1,3,5-triyl-tris(ethyne-2,1-diyl)]tribenzoate, and BPDC is biphenyl-4,4′-dicarboxylate; Zn₄O(BTB)₂, wherein BTB is 1,3,5-benzenetribenzoate; Zn₄O(BBC)₂, wherein BBC is 4,4′,4″-[benzene-1,3,5-triyl-tris(benzene-4,1-diyl)]tribenzoate; Zn₄O(BDC)₃, wherein BDC is 1,4-benzenedicarboxylate; Mn₃[(Mn₄Cl)₃(BT)₈]₂, where BTT is benzene-1,3,5-tris(1H-tetrazole); and Cu₃(BTC)₂(H₂O)₃, wherein BTC is 1,3,5-benzenetricarboxylic acid; (6) the CO₂-sorbing amine comprising one or more amine(s) selected from the group consisting of primary, secondary and tertiary alkylamines and alkanolamines, aromatic amines, mixed amines, polyamines and combinations thereof; (7) the CO₂-sorbing amine comprising one or more amine(s) selected from the group consisting of monoethanolamine (MEA), triethanolamine (TEA), diethanolamine (DEA), diethylenetriamine (DETA), 2-(2-aminoethylamino)ethanol, diisopropanolamine, 2-amino-2-methyl-1,3-propanediol, penaethylenehexamine, tetramethylenepentaamine, tetraethylenepentamine (TEPA), methyldiethanolamine (MDEA), polyallylamines, aminosilanes, tetraalkoxysilanes, aminoalkylalkoxysilanes, hyperbranched aminosilica (HAS), polymeric amines, and combinations and mixtures including one or more of the foregoing; (8) the CO₂-sorbing amine comprising one or more polyalkyleneimine(s); (9) the CO₂-sorbing amine comprises one or more polyethyleneimine(s); (10) the CO₂-sorbing amine comprising polyethyleneimine, tetraethylenepentamine, or polypropyleneimine; (11) the ionic liquid being interactive with the CO₂-sorbing amine to enhance at least one of the sorbent characteristics of (i) CO₂ sorption capacity, (ii) CO₂ sorption rate, (iii) CO₂ desorption capacity, (iv) CO₂ desorption rate, and (v) regeneration temperature, in relation to a corresponding sorbent lacking the ionic liquid; (12) the ionic liquid comprising one or more ionic liquid(s) selected from the group consisting of ammonium-, imidazolium-, phosphonium-, pyridinium-, pyrrolidinium-, and sulfonium-based ionic liquids; (13) the ionic liquid comprising one or more ionic liquid(s) selected from the group consisting of ionic liquids comprising one or more of cations

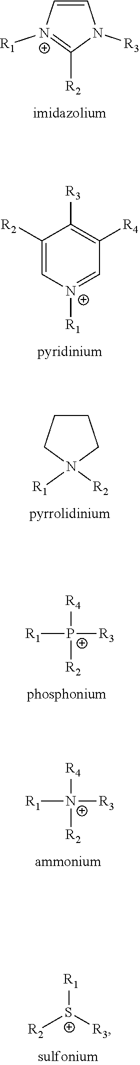

and associated organic or inorganic anions; (14) the organic or inorganic anions being selected from the group consisting of

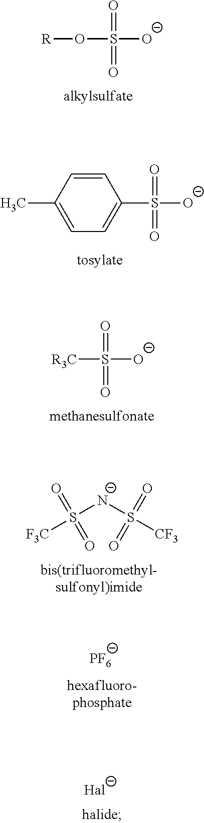

(15) the ionic liquid comprising one or more ionic liquid(s) selected from the group consisting of:
1-decyl-3-methylimidazolium bis(trifluoromethylsulfonyl)imide;
1-ethyl-3-methylimidazolium tetrafluoroborate;
1-ethyl-3-methylpyridinium bis(trifluoromethylsulfonyl)imide;
1-ethylpyridinium bromide;
1-hexyl-3-methylimidazolium triflate;
1,2-dimethyl-3-propylimidazolium bis(trifluoromethylsulfonyl)imide;
1,2-dimethyl-3-propylimidazolium bromide;
1,2-dimethyl-3-propylimidazolium iodide;
1,2-dimethylimidazole;
1,2-dimethylimidazolium chloride;
1,2-dimethylimidazolium bis(trifluoromethylsulfonyl)imide;
1,3-diethylimidazolium bis(trifluoromethylsulfonyl)imide;
1,3-diethylimidazolium bromide;
1,3-diethylimidazolium tetrafluoroborate;
1-(2-hydroxyethyl)-3-methylimidazolium bis(trifluoromethylsulfonyl)imide;
1-allyl-3-methylimidazolium bis(trifluoromethylsulfonyl)imide;
1-benzyl-3-methylimdiazolium 1,1,2,2-tetrafluoroethanesulfonate;
1-benzyl-3-methylimidazolium bis(trifluoromethylsulfonyl)imide;
1-butyl-1-methylpiperidinium bis(trifluoromethylsulfonyl)imide;
1-decyl-3-methylimidazolium hexafluorophosphate;
1-dodecyl-3-methylimidazolium bis(trifluoromethylsulfonyl)imide;
i-ethyl-1-methylpyrrolidinium hexafluorophosphate;
1-ethyl-3-methylimidazolium hexafluorophosphate;
1-ethyl-4-methylpyridinium bis(trifluoromethylsulfonyl)imide;
1-heptyl-3-methylimidazolium bis(trifluoromethylsulfonyl)imide;
1-hexadecyl-3-methylimidazolium hexafluorophosphate;
1-hexyl-1-methylpyrrolidinium bis(trifluoromethylsulfonyl)imide;
1-methylimidazolium bis(trifluoromethylsulfonyl)imide;
1-propyl-4-methylpyridinium bromide;
bis(1-butyl-3-methylimidazolium) tetrathiocyanatocobaltate;
diethylmethylsulfonium bis(trifluoromethylsulfonyl)imide;
trihexyltetradecylphosphonium bis(trifluoromethylsulfonyl)imide; and
triphenylcarbenium tetrakis(perfluoro-tert-butoxy) aluminate;
   (16) the ionic liquid comprising

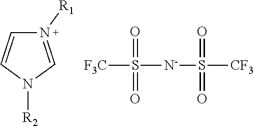

wherein each of R₁ and R₂ is independently selected from H, hydroxy, halo (F, Br, Cl, I), C₁-C₁₂ alkyl, C₁-C₁₂ alkoxy, C₁-C₁₂ carboxy, C₁-C₁₂ haloalkyl, C₆-C₁₂ aryl, C₆-C₁₄ arylalkyl, C₅-C₁₀ cycloalkyl, amino or substituted amino, thiol, phosphate, sulfate, phosphonate, and sulfonate; (17) each of R₁ and R₂ being independently selected from C₁-C₁₂ alkyl; (18) the ionic liquid comprising a substituted imidazolium group and a bis(trifluoromethylsulfonyl)imide group, wherein substituent(s) of the substituted imidazolium group are each independently selected from among organo substituents; (19) the sorbent comprising from 1 to 5000 ppm by weight of the ionic liquid, based on total weight of the amine present on the solid support; (20) the sorbent comprising from 10 to 1000 ppm by weight of the ionic liquid, based on total weight of the amine present on the solid support; and (21) the sorbent comprising from 1 to 100 ppm by weight of the ionic liquid, based on total weight of the amine present on the solid support.

The disclosure in another aspect contemplates a method of making a CO₂ capture sorbent, comprising depositing CO₂-sorbing amine and ionic liquid on a solid support.

The disclosure in a further aspect contemplates a method of making a CO₂ capture sorbent, comprising depositing ionic liquid on a solid support having an amine thereon.

In a still further aspect, the disclosure contemplates a method of making a CO₂ capture sorbent, comprising: depositing a CO₂-sorbing amine on a solid support, to form an aminated support; and depositing ionic liquid on the aminated support to form the CO₂ capture sorbent comprising the solid support with the CO₂-sorbing amine and ionic liquid thereon, and such method may optionally be performed wherein (1) such depositing ionic liquid on the aminated support comprises contacting the aminated support with an alkanolic solution of the ionic liquid to impregnate the aminated support with the ionic liquid, recovering the ionic liquid-impregnated aminated support from the alkanolic solution, and removing alkanol from the recovered ionic liquid-impregnated aminated support to yield the CO₂ capture sorbent comprising the solid support with the CO₂-sorbing amine and ionic liquid thereon, and optionally wherein (2) such removing alkanol from the recovered ionic liquid-impregnated aminated support comprises evaporating the alkanol from the recovered ionic liquid-impregnated aminated support.

The disclosure in another aspect contemplates a method of CO₂ capture, comprising contacting a CO₂-containing gas with a sorbent comprising a solid support with CO₂-sorbing amine and ionic liquid thereon, to produce CO₂-reduced gas, and sorbent having CO₂ adsorbed thereon, wherein the method optionally includes any one or more of the following features: (1) further comprising: regenerating the sorbent having CO₂ adsorbed thereon, to desorb CO₂ therefrom to form regenerated sorbent, and CO₂ desorbate; and recovering the CO₂ desorbate from the regenerated sorbent; (2) the method being conducted in a multi-bed system comprising multiple beds of the sorbent arranged for continuous CO₂ capture processing of the CO₂-containing gas, wherein one or more of the multiple beds is on-stream for said contacting of the CO₂-containing gas with the sorbent, and another or others of the multiple beds is off-stream and while off-stream said regenerating and recovering are carried out, with each of the multiple beds undergoing sequential on-stream and off-stream operations in a cyclic repeating sequence for said continuous CO₂ capture processing of the CO₂-containing gas; (3) the multi-bed system being a pressure-swing adsorption (PSA) multi-bed system; (4) the multi-bed system being a thermal-swing adsorption (TSA) multi-bed system; (5) the multi-bed system being a pressure-swing adsorption/thermal-swing adsorption (PSA/ISA) multi-bed system; (6) the CO₂-containing gas being air; (7) the CO₂-containing gas being supplied from a combustion process; (8) the CO₂-containing gas comprising effluent from an electrical power-generating plant; (9) the CO₂-containing gas comprising effluent from a motive vehicle; (10) the CO₂-containing gas being supplied from an oxidation process; (11) the oxidation process being a biological oxidation process; (12) the CO₂-containing gas comprising CO₂-containing gas produced by combustion of fossil fuel; (13) the CO₂-containing gas comprising syngas from organic matter gasification; (14) the CO₂-containing gas comprising blast furnace exhaust gas from steel making; (15) the CO₂-containing gas comprising cement kiln exhaust gas;
(16) the CO₂-containing gas comprising one or more of:
coal-fired power plant flue gas;
natural gas combined cycle power plant flue gas;
blast furnace exhaust gas;
cement plant exhaust gas;
natural gas fired once through steam generator gas;
steam methane reformer syngas;
steam methane reformer flue gas;
steam methane reformer PSA tail gas;
dry reforming syngas;
integrated gasification combined cycles (IGCC) syngas;
biogas;
biomass gasification syngas;
municipal waste gasification syngas; and atmospheric gas.

The disclosure in another aspect contemplates a CO₂ capture system comprising at least one sorption vessel containing a CO₂ capture sorbent comprising a solid support with CO₂-sorbing amine and ionic liquid thereon, wherein the vessel is arranged for contacting of CO₂-containing gas with the sorbent therein and discharge of CO₂-reduced contacted gas, and such system may optionally include any one or more of the following features: (1) the vessel is constituted and arranged for regeneration of the sorbent after at least partial loading of CO₂ thereon resulting from said contacting; (2) comprising multiple sorption vessels constituted and arranged for cyclic repeating operation comprising adsorption operation and desorption regeneration operation; (3) the system being constituted and arranged for thermal swing operation; (4) the system being constituted and arranged for pressure swing operation; and (5) the system being constituted and arranged for thermal swing and pressure swing operation.

While the disclosure has been set forth herein in reference to specific aspects, features and illustrative embodiments, it will be appreciated that the utility of the disclosure is not thus limited, but rather extends to and encompasses numerous other variations, modifications and alternative embodiments, as will suggest themselves to those of ordinary skill in the field of the present disclosure, based on the description herein. Correspondingly, the disclosure as hereinafter claimed is intended to be broadly construed and interpreted, as including all such variations, modifications and alternative embodiments, within its spirit and scope.

1. A sorbent useful for CO₂ capture, comprising a solid support with CO₂-sorbing amine and ionic liquid thereon, wherein the ionic liquid is interactive with the CO₂-sorbing amine to enhance at least one of the sorbent characteristics of (i) CO₂ sorption capacity, (ii) CO₂ sorption rate, (iii) CO₂ desorption capacity, (iv) CO₂ desorption rate, and (v) regeneration temperature, in relation to a corresponding sorbent lacking the ionic liquid.

2. The sorbent of claim 1, wherein the solid support comprises one or more material(s) selected from the group consisting of: carbon, silica, porous silicon, zeolites, metal oxides, mixed metal oxides, aluminosilicates, metal organic frameworks (MOFs), clays, mesoporous materials, fabrics, non-woven materials, ceramic monoliths, metal monoliths, ceramic-metal monoliths, polymers, porous polymer networks, and mixtures, alloys, and combinations including any one or more of the foregoing.

3.-4. (canceled)

5. The sorbent of claim 1, wherein the solid support comprises one or more metal organic frameworks (MOFs), wherein the one or more MOFs comprise(s) at least one selected from the group consisting of: Zn₄O(BTE)(BPDC) wherein BTE is 4,4′,4″-[benzene-1,3,5-triyl-tris(ethyne-2,1-diyl)]tribenzoate, and BPDC is biphenyl-4,4′-dicarboxylate; Zn₄O(BTB)₂, wherein BTB is 1,3,5-benzenetribenzoate Zn₄O(BBC)₂, wherein BBC is 4,4′,4″-[benzene-1,3,5-triyl-tris(benzene-4,1-diyl)]tribenzoate; Zn₄O(BDC)₃ wherein BDC is 1,4-benzenedicarboxylate; Mn₃[(Mn₄Cl)₃(BTT)₈]₂, where BTT is benzene-1,3,5-tris(1H-tetrazole); and Cu₃(BTC)₂(H₂O)₃, wherein BTC is 1,3,5-benzenetricarboxylic acid.

6. (canceled)

7. The sorbent of claim 1, wherein the CO₂-sorbing amine comprises:
(i) one or more amine(s) selected from the group consisting of primary, secondary and tertiary alkylamines and alkanolamines, aromatic amines, mixed amines, polyamines and combinations thereof;
(ii) one or more amine(s) selected from the group consisting of monoethanolamine (MEA), triethanolamine (TEA), diethanolamine (DEA), diethylenetriamine (DETA), 2-(2-aminoethylamino)ethanol, diisopropanolamine, 2-amino-2-methyl-1,3-propanediol, pentaethylenehexamine, tetramethylenepentaamine, tetraethylenepentamine (TEPA), methyldiethanolamine (MDEA), polyallylamines, aminosilanes, tetraalkoxysilanes, aminoalkylalkoxysilanes, hyperbranched aminosilica (HAS), polymeric amines, and combinations and mixtures including one or more of the foregoing;
(iii) one or more polyalkyleneimine(s); or
(iv) one or more polyethyleneimine(s).

8.-10. (canceled)

11. The sorbent of claim 1, wherein the CO₂-sorbing amine comprises polyethylene imine, tetraethylenepentamine, or polypropyleneimine.

12. (canceled)

13. The sorbent of claim 1, wherein the ionic liquid comprises one or more ionic liquid(s) selected from the group consisting of ammonium-, imidazolium-, phosphonium-, pyridinium-, pyrrolidinium-, and sulfonium-based ionic liquids.

14. The sorbent of claim 1, wherein the ionic liquid comprises one or more ionic liquid(s) selected from the group consisting of ionic liquids comprising one or more of cations 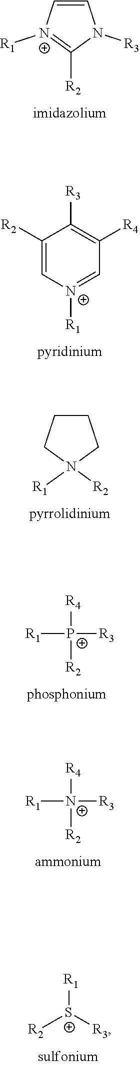
and associated organic or inorganic anions.

15. The sorbent of claim 14, wherein the organic or inorganic anions are selected from the group consisting of

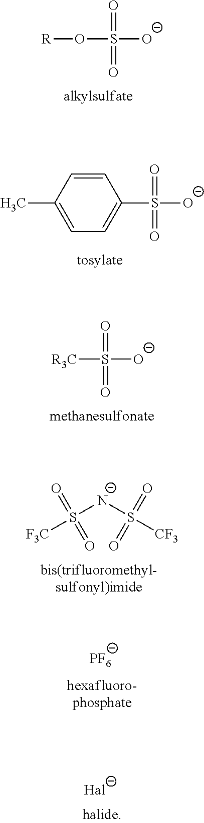

16. The sorbent of claim 1, wherein the ionic liquid comprises one or more ionic liquid(s) selected from the group consisting of:
1-decyl-3-methylimidazolium bis(trifluoromethylsulfonyl)imide;
1-ethyl-3-methylimidazolium tetrafluoroborate;
1-ethyl-3-methylpyridinium bis(trifluoromethylsulfonyl)imide;
1-ethylpyridinium bromide;
1-hexyl-3-methylimidazolium triflate;
1,2-dimethyl-3-propylimidazolium bis(trifluoromethylsulfonyl)imide;
1,2-dimethyl-3-propylimidazolium bromide;
1,2-dimethyl-3-propylimidazolium iodide;
1,2-dimethylimidazole;
1,2-dimethylimidazolium chloride;
1,2-dimethylimidazolium bis(trifluoromethylsulfonyl)imide;
1,3-diethylimidazolium bis(trifluoromethylsulfonyl)imide;
1,3-diethylimidazolium bromide;
1,3-diethylimidazolium tetrafluoroborate;
1-(2-hydroxyethyl)-3-methylimidazolium bis(trifluoromethylsulfonyl)imide;
1-allyl-3-methylimidazolium bis(trifluoromethylsulfonyl)imide;
1-benzyl-3-methylimdiazolium 1,1,2,2-tetrafluoroethanesulfonate;
1-benzyl-3-methylimidazolium bis(trifluoromethylsulfonyl)imide;
1-butyl-1-methylpiperidinium bis(trifluoromethylsulfonyl)imide;
1-decyl-3-methylimidazolium hexafluorophosphate;
1-dodecyl-3-methylimidazolium bis(trifluoromethylsulfonyl)imide;
1-ethyl-1-methylpyrrolidinium hexafluorophosphate;
1-ethyl-3-methylimidazolium hexafluorophosphate;
1-ethyl-4-methylpyridinium bis(trifluoromethylsulfonyl)imide;
1-heptyl-3-methylimidazolium bis(trifluoromethylsulfonyl)imide;
1-hexadecyl-3-methylimidazolium hexafluorophosphate;
1-hexyl-1-methylpyrrolidinium bis(trifluoromethylsulfonyl)imide;
1-methylimidazolium bis(trifluoromethylsulfonyl)imide;
1-propyl-4-methylpyridinium bromide;
bis(1-butyl-3-methylimidazolium) tetrathiocyanatocobaltate;
diethylmethylsulfonium bis(trifluoromethylsulfonyl)imide;
trihexyltetradecylphosphonium bis(trifluoromethylsulfonyl)imide; and
triphenylcarbenium tetrakis(perfluoro-tert-butoxy) aluminate.

17. The sorbent of claim 1, wherein the ionic liquid comprises 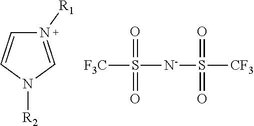
wherein each of R₁ and R₂ is independently selected from H, hydroxy, halo (F, Br, Cl, I), C₁-C₁₂ alkyl, C₁-C₁₂ alkoxy, C₁-C₁₂ carboxy, C₁-C₁₂ haloalkyl, C₆-C₁₂ aryl, C₆-C₁₄ arylalkyl, C₅-C₁₀ cycloalkyl, amino or substituted amino, thiol, phosphate, sulfate, phosphonate, and sulfonate.

18. (canceled)

19. The sorbent of claim 1, wherein the ionic liquid comprises a substituted imidazolium group and a bis(trifluoromethylsulfonyl)imide group, wherein substituent(s) of the substituted imidazolium group are each independently selected from among organo substituents.

20. The sorbent of claim 1, comprising from 1 to 5000 ppm by weight of the ionic liquid, based on total weight of the amine present on the solid support.

21.-24. (canceled)

25. A method of making a CO₂ capture sorbent, comprising:
depositing a CO₂-sorbing amine on a solid support, to form an aminated support; and
depositing ionic liquid on the aminated support to form the CO₂ capture sorbent comprising the solid support with the CO₂-sorbing amine and ionic liquid thereon,
wherein said depositing ionic liquid on the aminated support comprises contacting the aminated support with an alkanolic solution of the ionic liquid to impregnate the aminated support with the ionic liquid, recovering the ionic liquid-impregnated aminated support from the alkanolic solution, and removing alkanol from the recovered ionic liquid-impregnated aminated support to yield the CO₂ capture sorbent comprising the solid support with the CO₂-sorbing amine and ionic liquid thereon, and
wherein said removing alkanol from the recovered ionic liquid-impregnated aminated support comprises evaporating the alkanol from the recovered ionic liquid-impregnated aminated support.

26.-27. (canceled)

28. A method of CO₂ capture, comprising contacting a CO₂-containing gas with a sorbent according to claim 1, to produce CO₂-reduced gas, and sorbent having CO₂ adsorbed thereon.

29. The method of claim 28, further comprising:
regenerating the sorbent having CO₂ adsorbed thereon, to desorb CO₂ therefrom to form regenerated sorbent, and CO₂ desorbate; and
recovering the CO₂ desorbate from the regenerated sorbent.

30. The method of claim 29, wherein the method is conducted in a multi-bed system comprising multiple beds of the sorbent arranged for continuous CO₂ capture processing of the CO₂-containing gas, wherein one or more of the multiple beds is on-stream for said contacting of the CO₂-containing gas with the sorbent, and another or others of the multiple beds is off-stream and while off-stream said regenerating and recovering are carried out, with each of the multiple beds undergoing sequential on-stream and off-stream operations in a cyclic repeating sequence for said continuous CO₂ capture processing of the CO₂-containing gas.

31.-33. (canceled)

34. The method of claim 28, wherein the CO₂-containing gas is air.

35.-39. (canceled)

40. The method of claim 28, wherein the CO₂-containing gas comprises CO₂-containing gas produced by combustion of fossil fuel.

41.-43. (canceled)

44. The method of claim 28, wherein the CO₂-containing gas comprises one or more of:
coal-fired power plant flue gas;
natural gas combined cycle power plant flue gas;
blast furnace exhaust gas;
cement plant exhaust gas;
natural gas fired once through steam generator gas;
steam methane reformer syngas;
steam methane reformer flue gas;
steam methane reformer PSA tail gas;
dry reforming syngas;
integrated gasification combined cycles (IGCC) syngas;
biogas;
biomass gasification syngas;
municipal waste gasification syngas; and
atmospheric gas.

45. A sorbent according to claim 1, as disposed in a CO₂ capture system comprising at least one sorption vessel containing the sorbent, wherein the vessel is arranged for contacting of CO₂-containing gas with the sorbent therein and discharge of CO₂-reduced contacted gas.

46.-50. (canceled)
